(19) United States
(12) Patent Application Publication
(10) Pub. No.: US 2009/0169708 A1
(43) Pub. Date: Jul. 2, 2009

(54) PROCESS AND PLANT FOR THE PRODUCTION OF PRECOOKED AND GELATINIZED FLOURS FOR FOOD PRODUCTS

(75) Inventors: Enrico FAVA, CENTO (FERRARA) (IT); Anzio STORCI, COLLECCHIO (PARMA) (IT)

Correspondence Address: YOUNG & THOMPSON, 209 Madison Street, Suite 500, ALEXANDRIA, VA, 22314, US

(73) Assignees: STORCI S.P.A., COLLECCHIO (IT); FAVA S.P.A., CENTO (IT)

(21) Appl. No.: 12/345,067

(22) Filed: Dec. 29, 2008

(30) Foreign Application Priority Data
Dec. 27, 2007 (IT) MI2007A 002438

(51) Int. Cl. A21D 6/00; A23L 1/10; A21D 13/00

(52) U.S. Cl. 426/622; 426/510; 99/352; 426/463; 426/504; 426/502; 99/355

(57) ABSTRACT

A process and plant for the production of precooked and gelatinized cereal-based food flours, particularly rise, corn and buckwheat flours, for use in the production of pasta and other food products. The raw untreated flour, possibly with ingredients added thereto, undergoes hydration after being mixed with a metered amount of water, in a fast mixer. Then, the hydrated flour is formed into a layer on a substrate to undergo precooking and gelatinization by steam treatment. The gelatinized flour may be dried into a half-processed flour for later processing or may be processed, after a cooling step, with other ingredients and/or water for the production of fresh or dry pasta or other food products.

### FIELD OF INVENTION

The present invention addresses improvements to food flour production technology, and is particularly directed to a process and plant for the production of cereal-based food flours, in which the flour is precooked and gelatinized by a particular steam treatment, for the production of either fresh or dry pasta, and other food products; while the invention is suitable for the production of food products based on precooked and gelatinized products with or without gluten, it particularly finds application with gluten-free flours such as corn, rice, buckwheat flours.

### BACKGROUND OF THE INVENTION

Current food flour precooking and gelatinization plants do not ensure sufficient quality consistency, great changes being involved in the degree of precooking and gelatinization; this is caused by the difficulties in the management of process parameters, which provide food products of poorly uniform characteristics. This problem is obviated in certain non industrial systems, which are poorly profitable and unsuitable for industrial production capacities, due to very long processing time, above 24 hours.

The problem of controlling and obtaining an optimal and consistent precooking and gelatinization throughout the production process depends on a number of factors, particularly on the precooking and gelatinization treatment methods.

Flour gelatinization is generally required both for easily digestible food products, particularly for the production of gluten-containing flour-based baby food and gluten-free flour based-food products in the production of fresh and/or dry pasta.

In currently known and used technologies, flour gelatinization occurs with the raw material as it is, or during kneading and/or post-kneading; examples are disclosed in EP-A-0,872,188 and US-A2007/0,190,216.

Particularly, EP-A-0,872,188 discloses a method for preparing gluten-free pasta, which uses steam as a source of wet heat required for gelatinization of flour starch, but it does not indicate the times and methods for heat application.

On the other hand, US-A-2007/0,190,216 discloses a method and plant which includes a steam heating step during and after kneading. Here again no particular specifications are provided concerning the times and method of heating.

Therefore, typical prior art approaches appear to involve gelatinization by direct heating of the flour and dough during or immediately after kneading. Therefore, apparent difficulties are encountered in achieving a homogeneous and consistent degree of gelatinization throughout the production process, and from one process to another, which affect the quality of the final food product.

Hence, there arises the need of providing new solutions allowing improved process management and providing consistent and repeatable results. In view of obviating prior art drawbacks, and achieving the improvement purposes and advantages, the Applicant has conceived, tested and implemented an improved process and plant for the production of precooked and gelatinized food flours according to the present invention.

As used herein, the term “flour” is intended to indicate any semolina and common flour obtained by cereal milling.

### OBJECTS OF THE INVENTION

The main object of the present invention is to provide a process and plant for the production of precooked and gelatinized food flours with or without gluten, allowing management and adequate control of the precooking and gelatinization process throughout the production process.

Another object is to provide a method that achieves a high gelatinization degree, and ensures result consistency in the processed food product.

Yet another object is to provide a process and plant that meet the current requirement of technologies capable of ensuring uniform treatment in flours and in the corresponding precooked and gelatinized food products.

### BRIEF DESCRIPTION OF THE INVENTION

The guiding principle of the present invention consists in that a flour precooking and gelatinization step is carried out using steam, on a flour layer previously subjected to a hydration step; this provides partial or total precooking and gelatinization of flour starches in a substantially homogeneous and consistent manner.

This may be achieved by a process for the production of precooked and gelatinized food flours as defined in claim 1, as well as a plant as defined in claim 12.

In a first aspect, the invention provides a process for the production of precooked and gelatinized food flours, in which the flour undergoes a precooking and gelatinization step by steam treatment, characterized by the following steps:

hydrating the flour by mixing it with a metered amount of water;

forming the hydrated flour into a thin layer on a substrate;

treating the hydrated flour layer with steam; and

maintaining the flour layer under steam treatment until precooking and gelatinization is obtained.

The precooked and gelatinized flour may be later dried, milled and stabilized for storage and use in the preparation of food products, particularly precooked and gelatinized pasta, with or without gluten.

In a further development of the process, the precooked and gelatinized flour, in distinct granules, may be cooled and subjected to an additional hydration step and/or mixed with other ingredients.

In yet another aspect, the invention provides a plant for carrying out the flour precooking and gelatinization process of the invention, characterized in that it comprises:

a first mixer designed to mix and hydrate the flour;

means for feeding the hydrated flour and forming it in granular form into a layer on a substrate, for precooking and gelatinization;

means for steam treatment of the granular hydrated flour layer on said substrate and for maintaining it at a precooking and gelatinization temperature.

Further aspects and characteristics of the process and plant of the present invention will be defined in the dependent claims attached hereto.

### BRIEF DESCRIPTION OF THE DRAWINGS

The invention will be now described in greater detail with reference to the attached drawings in which:

FIG. 1 is a schematic view of a first plant for the production of precooked and gelatinized flours of the invention;

FIG. 2 shows an enlarged detail of FIG. 1;

FIG. 3 is a schematic view of a second plant for the production of precooked and gelatinized pasta and/or food products of the invention;

FIG. 4 is an illustrative flow chart of the plant of FIG. 1;

FIG. 5 is an illustrative flow chart of the plant of FIG. 3.

### DETAILED DESCRIPTION OF THE INVENTION

The present invention is based on the observation that consistent and homogeneous precooking and gelatinization of flours may be achieved by a steam treatment of a raw hydrated flour formed into a thin layer on a substrate, such as a vapor-permeable belt conveyor.

For the purposes hereof, the term “thin layer” is intended to indicate a layer of hydrated flour whose thickness allows uniform heating of the whole mass, such as a thickness of 15 cm or less, preferably of 2 to 10 cm.

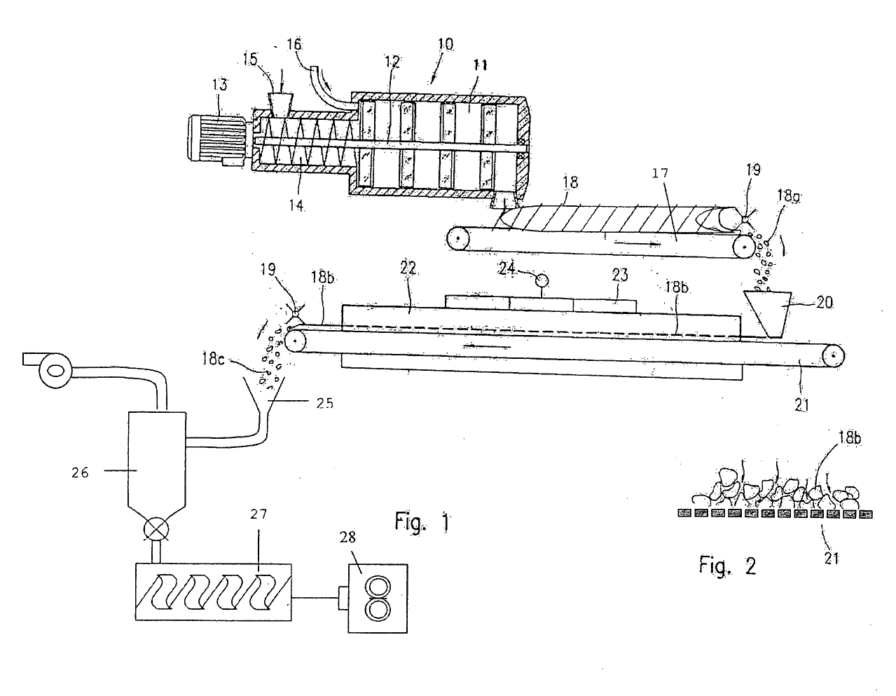

A possible plant for the production of a precooked and gelatinized flour is shown by way of example in FIG. 1. The plant is composed of a fast mixer 10, e.g. comprising a cylindrical mixing chamber 11 with a bladed rotor 12 driven by a motor 13. A metering screw 14 is placed upstream from the mixing chamber 11 and is controlled by the motor 13 of the mixer; numeral 15 designates a hopper for loading the raw, untreated flour, possibly pre-mixed with other ingredients, whereas numeral 16 designates a hydration water feeding conduit.

The hydrated flour that comes out of the mixer 10 falls onto a first belt conveyor 17 on which it is formed into a layer 18, and is maintained on the conveyor 17 for a predetermined period of time, required to ensure homogeneous hydration of every flour granule, e.g. for a rest time of 4 to 12 minutes.

At the end of the conveyor 17, a grain separator device 19 allows the flour to fall in separate granules 18a into the hopper of an underlying layer-forming device 20, which is located at the start of a second vapor-permeable belt conveyor 31, to form a thin layer 18b, as mentioned above.

The belt conveyor 21 extends along a steam treatment apparatus comprising a tunnel 22 along which the layer of hydrated flour is precooked and gelatinized, and a piping system 23 that feeds saturated steam at about 100° C. from a steam generator 24 into the tunnel 22.

Therefore, the process for precooking and gelatinizing the granular flour, formed into a thin layer as mentioned above, is carried out in a steam saturated environment, at or slightly above atmospheric pressure. Tests on various types of flours showed that the creation of a layer of granular hydrated flour improves penetration and spreading of steam into the entire thickness of the granular flour, as shown in FIG. 2.

At the end of the precooking and gelatinization step, the flour that comes out of the heat treatment tunnel 22 will have a temperature slightly lower than steam, e.g. a temperature of about 98° C. After grain separation 18c by the grain separator 19, the flour falls into a collection hopper 25 and transferred by a pneumatic conveyor system 26 to a dryer 27.

The dryer 27 and a succeeding calibrating mill 28 provide a calibrated dry flour, stabilized for storage, and adapted for later use in the preparation of various food products, such as precooked and gelatinized pasta, with or without gluten.

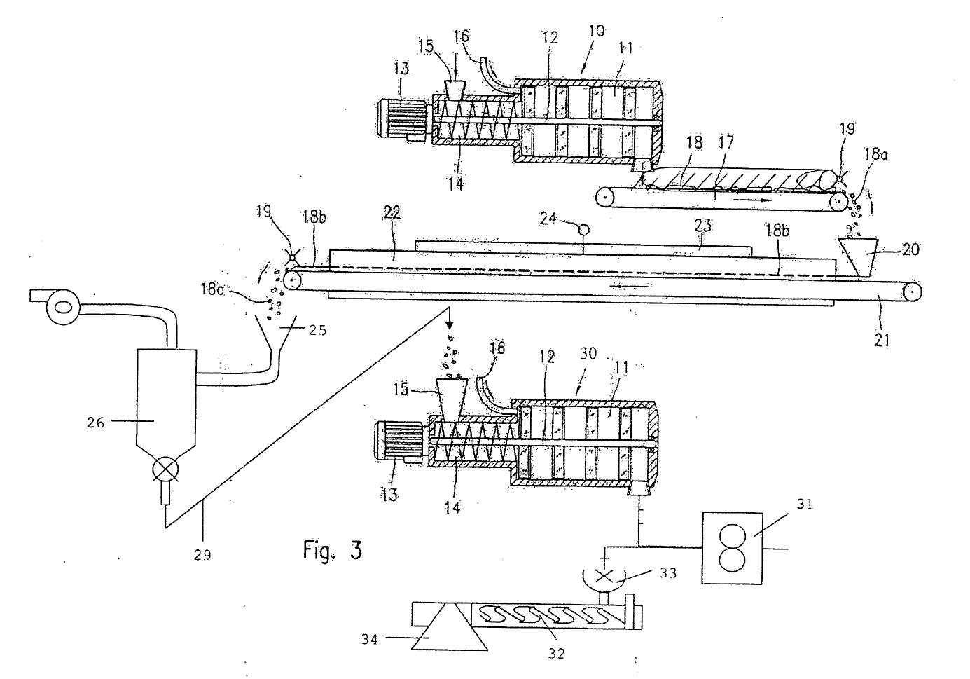

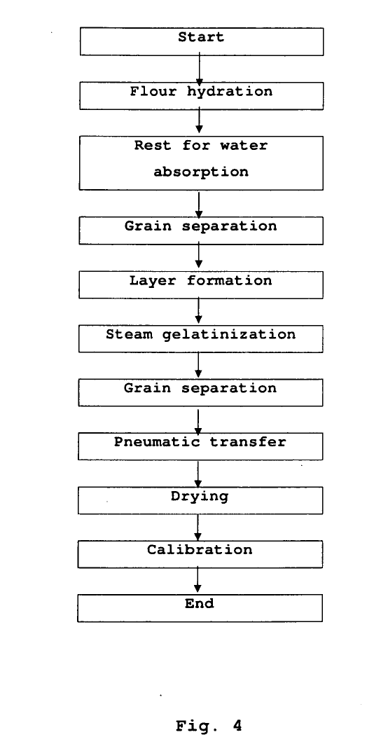

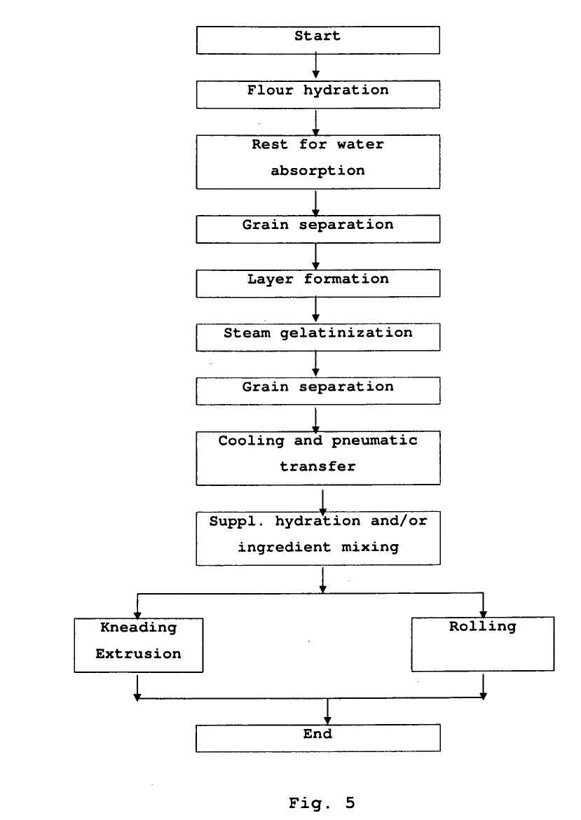

FIG. 3 shows a second plant for the production of precooked and gelatinized pasta and/or food products using a precooked and gelatinized flour of the invention; since this is a development of the process and plant of FIG. 1, FIG. 4 uses the same reference numerals to designate similar or equivalent parts.

Once more, in the case of FIG. 3, the layer of precooked and gelatinized flour 18b that comes out of the tunnel 22, undergoes grain separation into separate granules 18c by the grain separator device 19, and falls into a collection hopper 25 which feeds the pneumatic conveyor system 26, with the purpose of cooling the product.

After cooling to a temperature of 25° C. to 45° C., the flour is fed via a conduit 29 into a second mixer to undergo a second supplementary hydration step and/or be mixed with further liquid ingredients, e.g. in a mixer 30 similar to or different from the one mentioned above.

Then, the rehydrated flour may be subjected to rolling by a rolling mill 31 or extrusion by an extruder 32 comprising a blade mixer 33 and an drawing unit 34: the latter provides fresh pasta possibly designed for further drying.

The block diagrams of FIGS. 4 and 5 show the main steps of the process and plant of FIGS. 1 and 3 of the invention, with reference to any type of flour, with or without gluten, regardless of its later use.

As shown in FIG. 4, after the start of the production process, the appropriately metered flour is hydrated and possibly mixed with other ingredients. The degree of hydration depends on the properties of the flour in use, and may be determined according to process requirements; by way of illustration, it will fall in a range from 25% to 40%.

The next step is a rest step, which is carried out as the hydrated flour is conveyed by the conveyor 17, and is designed to allow the hydration water to uniformly reach the granule core. Then, the dough is subjected to grain separation, formed into a layer of predetermined thickness, as defined above, on the support belt 21, to continue its path and be subjected to a precooking and gelatinization step by steam in the tunnel 22. For example, a temperature of about 98° C. will be reached and maintained for a predetermined time, as needed, and anyway controlled within a given time interval, e.g. of or below 15 minutes, preferably from 3 to 15 minutes, and depending on steam temperature and on heating time, the flour granules will be more or less precooked and gelatinized. Therefore, this method provides quick homogeneous distribution of heat within the whole flour mass.

Then the precooked and gelatinized flour will be subjected to grain separation and transferred to a drying station by a pneumatic conveyor or any other suitable means, whereupon a last step may be carried out, i.e. calibration of the dry flour by milling.

As an alternative of the above, the block diagram of FIG. 5 shows a method which s similar to the one described above up to the precooking, gelatinization and grain separation step, and is completed by different unit steps.

Namely, the precooked and gelatinized separated flour, is transferred by pneumatic means and cooled, and is then fed into another mixer for supplementary hydration and mixed with other ingredients.

The dough so obtained may be directly used to produce extruded and drawn pasta, rolled pasta or different food products.

In short, a process and plant has been provided herein for improving the precooked and gelatinized flour preparation technology, in which the heating step is carried out with an ideal flour layer. Quick heat exchange and fast heat treatment times reduce the overall processing times of the process for the production of precooked and gelatinized flours and the food products that use them as a raw material.

It shall be understood that what has been described and illustrated herein with reference to the drawings is only provided by way of example; therefore, changes and/or variants may be made to the method and plant, or to the equipment thereof, without departure from the scope as defined by the claims.

1. A process for the production of precooked and gelatinized food flours for food products, in which the flour undergoes a precooking and gelatinization step by steam treatment, characterized by the following steps:
hydrating the flour by mixing it with a metered amount of water;
forming the hydrated flour into a thin layer on a substrate;
treating the hydrated flour layer with steam; and
maintaining the flour layer under steam heating until precooking and gelatinization is obtained.

2. A process as claimed in claim 1, characterized in that the hydrated flour is precooked and gelatinized by saturated steam in an environment at or slightly above atmospheric pressure.

3. A process as claimed in claim 1, characterized in that the step of precooking and gelatinizing the hydrated flour layer by steam lasts from 3 to 15 minutes.

4. A process as claimed in claim 1, characterized in that a layer of hydrated flour is formed on said substrate, which has a thickness of 15 cm or less.

5. A process as claimed in claim 4, characterized in that a layer of hydrated flour is formed, for precooking and gelatinization, which has a thickness of 2 to 10 cm.

6. A process as claimed in claim 1, characterized in that the flour is hydrated by mixing it with an amount of hydration water from 25% to 40% of the flour.

7. A process as claimed in claim 1, characterized in that flour hydration is completed, before grain separation and arrangement on the substrate for precooking and gelatinization, by forming a layer thereon, and maintaining the layer of hydrated flour at rest for a predetermined time.

8. A process as claimed in claim 1, characterized in that the precooked and gelatinized flour is dried and subjected to a later calibration step by milling.

9. A process as claimed in claim 1, characterized in that the flour is cooled after the precooking and gelatinization step.

10. A process as claimed in claim 9, characterized in that a second step of hydration and mixing of the precooked and gelatinized flour is carried out until a dough is obtained.

11. A process as claimed in claim 10, characterized in that it includes a step of extrusion or rolling of said dough.

12. A plant for precooking and gelatinizing food flours by the process as claimed in claim 1, characterized in that it comprises:
a first mixer designed to mix and hydrate the flour;
means for feeding the hydrated flour and forming it in granular form into a layer on a substrate, for precooking and gelatinization;
means for steam treatment of the granular hydrated flour layer on said substrate and for maintaining it at a precooking and gelatinization temperature.

13. A plant as claimed in claim 12, characterized in that said substrate for precooking and gelatinization of the hydrated flour layer is vapor permeable.

14. A plant as claimed in claim 13, characterized in that the means for forming the hydrated flour in granular form into a layer comprise:
a first belt conveyor extending along a steam treatment path for precooking and gelatinization, and a layer forming device at one end of the belt conveyor.

15. A plant as claimed in claim 14, characterized in that the means for heating, precooking and gelatinizing the granular hydrated flour layer by steam include a steam treatment tunnel which extends along said first belt conveyor.

16. A plant as claimed in claim 14, characterized in that it comprises means for supporting a layer of hydrated flour at rest, to complete hydration thereof downstream from said first mixer.

17. A plant as claimed in claim 16, characterized in that the support means for completing hydration of the flour include a second intermediate conveyor between the first mixer and the first conveyor.

18. A plant as claimed in claim 14, characterized in that it includes a second disintegration means and a second mixer for the precooked and gelatinized flour downstream from the first belt conveyor.

19. A plant as claimed in claim 18, characterized in that it includes a dryer for the precooked and gelatinized flour, and means for conveying the flour between said second disintegration means and said dryer.

20. A plant as claimed in claim 18, characterized in that it includes means for conveying and cooling the precooked and gelatinized flour, between said second disintegration means and said second mixer.

21. A plant as claimed in claim 12, characterized in that said mixers are rotary mixers, of the flat-bladed type.

22. A precooked and gelatinized flour obtained by the process as claimed in claim 1.

23. A food product obtained from a precooked and gelatinized flour as claimed in claim 22.

24. A plant as claimed in claim 1, characterized in that it comprises means for supporting a layer of hydrated flour at rest, to complete hydration thereof downstream from said first mixer.
